(19) United States
(12) Patent Application Publication
(10) Pub. No.: US 2023/0198014 A1
(43) Pub. Date: Jun. 22, 2023

(54) BATTERY CELL COMPRISING SPECIAL POROUS SOLID ELECTROLYTE FOAMS

(71) Applicant: RENAULT S.A.S, Boulogne-Billancourt (FR)

(72) Inventors: Nicolas BESNARD, Paris (FR); Victor CHAUDOY, Paris (FR)

(73) Assignee: RENAULT S.A.S, Boulogne-Billancourt (FR)

(21) Appl. No.: 17/999,089

(22) PCT Filed: May 11, 2021
(86) PCT No.: PCT/EP2021/062395

§ 371 Date: Nov. 17, 2022

(30) Foreign Application Priority Data
May 19, 2020 (FR) 20 05108

(51) Int. Cl. H01M 10/0565; H01M 4/04; H01M 4/62; H01M 50/414; H01M 50/403; H01M 50/46; H01M 4/139

(52) U.S. Cl. CPC H01M 10/0565; H01M 4/0416; H01M 4/0407; H01M 4/62; H01M 50/414; H01M 50/403; H01M 50/46; H01M 4/0471; H01M 4/139; H01M 2004/028

(57) ABSTRACT

A battery cell includes at least one positive electrode, at least one negative electrode, and at least one separator. The positive electrode includes a positive electrode porous solid-state electrolyte polymer foam that includes at least one lithium salt, and a positive electrode material located in the pores of the positive electrode foam. The negative electrode includes a negative electrode porous solid-state electrolyte polymer foam that includes at least one lithium salt, and a negative electrode material located in the pores of the negative electrode foam.

### TECHNICAL FIELD

The present invention relates to the field of all-solid-state batteries. More particularly, the present invention relates to an all-solid-state battery cell comprising at least one positive electrode and at least one negative electrode, each of the two electrodes comprising a porous solid-state electrolyte polymer foam.

The present invention also relates to a method for manufacturing such a battery cell.

### PRIOR ART

Conventionally, batteries comprise one or more positive electrodes, one or more negative electrodes, a separator, an anode current collector and a cathode current collector.

The performance of a battery depends on the ion and electron transport properties. In the case of an all-solid-state battery, ion transport at the electrode scale takes place through the network formed by the solid electrolyte (polymer, polymer+lithium salt, inorganic, hybrid polymer+inorganic). For such a battery to be in an operating state, this network is percolated, forming ionic conduction paths through the entire volume of the electrode, to ensure the transport of the ions to or from the assembly of active material particles.

In addition, a high energy density is sought at the cell scale, requiring thick electrodes comprising a greater amount of materials.

One of the difficulties encountered is that of ensuring a good distribution of the solid-state electrolyte in the electrode mixture. The thicker the electrode, the more difficult it is to achieve the quality of this distribution.

In addition, an all-solid-state battery application complicates the dispersion of the constituents because the electrolyte is added directly in the process of shaping the electrodes. In the positive electrode (called cathode), the solid-state electrolyte is called cathode ion-conducting material. In the negative electrode (called anode), the solid-state electrolyte is called anode ion-conducting material.

Poor distribution of the electrolyte leads to a decrease in the available energy and power performance, associated with the ion transport throughout the electrode volume (supply and collection of the ionic species) and with the charge transfer process (insertion/deinsertion of ions into/from the active materials of the positive and negative electrodes).

Lastly, an electrically insulating but ion-conducting separator is located at the interface between the two electrodes. In the case of a solid-state electrolyte battery, this is a preferentially nonporous film. It appears that the cathode ion-conducting material/separator and anode ion-conducting material/separator interfaces are critical. This is because a resistance can be observed at these interfaces. The resistance of these interfaces can limit ion transport and hence the performance of the battery, but also represent a zone of mechanical weakness that is critical for durability.

The patent EP 2 099 087 describes a method for filling a porous solid-state electrolyte with a precursor of active materials of an electrode via an immersion process.

The solution of electrode active materials comprises phosphate or oxide derivatives dispersed in a solvent. Once the structure has been soaked, drying at temperature makes it possible to evaporate the solvent, leaving the materials in the electrolyte structure. The porous solid-state electrolyte thus consists of oxides or phosphates. This method enables the production of all-solid-state cells.

The patent EP 2 099 087 focuses on the method for filling a porous solid-state electrolyte structure, that is to say the manufacture of a single electrode.

On the other hand, it does not take into account the environment of the electrode once the battery has been assembled. The advantage of such an electrolyte structure is that of ensuring the percolation of the ion transport network in order to ensure a three-dimensional distribution of the ionic species during the charging and discharging processes, and of doing so throughout the structure of the battery.

However, the patent is restricted to the scale of the electrode with the charge transfer process and the distribution of the ions within the volume of this same electrode. Thus, the patent EP 2 099 087 does not take into account the interface between the three-dimensional structure of the electrode and the separator film. This interface, if it is too resistive, will represent a barrier to the transport of the ionic species. This interface resistance depends in particular on the materials used as cathode ion-conducting material, anode ion-conducting material and separator film. The nature of the materials and the assembly process can have an influence on this interface.

The patent EP 2 099 087 makes no mention of these aspects. However, a solution, while possibly valid at the scale of the electrode, may not be compatible with a complete battery cell or a complete battery.

Furthermore, in the patent EP 2 099 087, and as indicated above, only oxides and phosphates are mentioned in the compatible electrode active materials.

In addition, the patent EP 2 099 087 describes ceramic solid-state electrolytes. The electrodes cited are in particular chosen from “LLT” electrodes (Li₃ₓLa_{2/3-x}TiO₃, with 0≤x≤⅔) or “LAMP” electrodes (Li₁₊ₓAlₓM₂₋ₓ(PO₄)₃, with 0≤x≤1, M being a tetravalent transition metal such as Ge, Ti, Zr). Said electrodes may also be a structure based on aluminum garnet or of garnet type containing lithium, lanthanum, zirconium and oxygen.

These various electrodes cited in the patent EP 2 099 087 are not completely satisfactory, in particular because the ion transport network comprises solid/solid interfaces that can represent significant resistances. In addition, ceramics require much lengthier shaping methods than polymer materials.

There is therefore a need to develop new battery cells comprising solid-state electrolytes making it possible to overcome the drawbacks mentioned above.

### DISCLOSURE OF THE INVENTION

It has been discovered that a battery cell, comprising a particular positive electrode, a particular negative electrode and a separator, makes it possible to not have any resistance at the interfaces while ensuring good ion transport throughout the battery.

The invention therefore provides a battery cell comprising at least one positive electrode, at least one negative electrode and at least one separator,

said positive electrode comprising:
a positive electrode porous solid-state electrolyte polymer foam, said positive electrode foam comprising at least one lithium salt, and
a positive electrode material, being located in the pores of said positive electrode foam,

said negative electrode comprising:
a negative electrode porous solid-state electrolyte polymer foam, said negative electrode foam comprising at least one lithium salt, and
a negative electrode material, being located in the pores of said negative electrode foam.

The invention further provides a battery comprising at least one battery cell according to the invention.

The invention also relates to a method for manufacturing a battery cell according to the invention.

It is specified that the expression “from . . . to . . . ” used in the present description of the invention should be understood as including each of the limits mentioned.

It is also specified that, hereinafter, expressions such as “positive electrode foam” and “positive electrode polymer foam” are equivalent to the expression “positive electrode porous solid-state electrolyte polymer foam”.

Likewise, hereinafter, expressions such as “negative electrode foam” and “negative electrode polymer foam” are equivalent to the expression “negative electrode porous solid-state electrolyte polymer foam”.

Furthermore, the term “drying at temperature” is understood within the meaning of the present invention to mean heating (which thus has a drying function) at a temperature greater than ambient temperature (and at atmospheric pressure), in particular heating at a temperature of greater than 25° C.

As indicated above, the battery cell according to the invention comprises at least one positive electrode, at least one negative electrode and at least one separator,

The separator is, in general, a polymer film.

Preferably, the assembly formed by said positive electrode, said negative electrode and said separator is in the form of a one-piece structure.

The term “one-piece structure” is understood within the meaning of the present invention to mean a single structure, that is to say a structure in which there is no positive electrode/separator or negative electrode/separator physical interface.

The characterization of such a structure can be done by scanning electron microscopy on a section of the sample, by measuring conductivity/resistivity. For example, a one-piece structure can be observed when there is an absence of demarcation between the three layers. In this case, there is no resistance associated with this interface and no capacitive phenomenon.

As indicated above, the positive electrode comprises a positive electrode porous solid-state electrolyte polymer foam, and the negative electrode comprises a negative electrode porous solid-state electrolyte polymer foam.

Advantageously, said positive electrode foam and said negative electrode foam are of the same chemical nature, that is to say that said polymer employed in the positive electrode foam and said polymer employed in the negative electrode foam belong to the same family of materials.

Preferably, the positive electrode foam comprises poly(ethylene oxide).

Advantageously, the positive electrode foam further comprises poly(vinylidene fluoride-co-hexafluoropropylene).

Preferentially, the negative electrode foam comprises poly(ethylene oxide).

According to a particular embodiment, the negative electrode foam further comprises poly(vinylidene fluoride-co-hexafluoropropylene).

Particularly preferably, the positive electrode foam and the negative electrode foam are identical and both comprise poly(ethylene oxide).

Very particularly, the positive electrode foam and the negative electrode foam are identical and both comprise poly(ethylene oxide) and poly(vinylidene fluoride-co-hexafluoropropylene).

As indicated above, the positive electrode polymer foam and the negative electrode polymer foam each comprise at least one lithium salt.

Advantageously, the lithium salt is chosen from lithium bis(trifluoromethanesulfonyl)imide (LiTFSI), lithium bis(fluorosulfonyl)imide (LiFSI), lithium hexafluorophosphate (LiPF₆), and mixtures thereof.

Preferably, the lithium salt included in the positive electrode polymer foam and the lithium salt included in the negative electrode polymer foam are identical.

According to a particular embodiment of the invention, the separator is a polymer film comprising poly(ethylene oxide).

Advantageously, the separator further comprises a polymer binder chosen from poly(vinylidene fluoride-co-hexafluoropropylene).

Preferably, the separator further comprises at least one lithium salt, preferably chosen from lithium bis(trifluoromethanesulfonyl)imide (LiTFSI), lithium bis(fluorosulfonyl)imide (LiFSI), lithium hexafluorophosphate (LiPF₆), and mixtures thereof.

Preferably, said positive electrode polymer foam and said negative electrode polymer foam and the separator are of the same chemical nature, that is to say that said polymer employed in the positive electrode polymer foam, said polymer employed in the negative electrode polymer foam and the polymer employed in the separator belong to the same family of materials.

Particularly preferably, the positive electrode foam, the negative electrode foam and the polymer film of the separator all comprise poly(ethylene oxide) and poly(vinylidene fluoride-co-hexafluoropropylene).

As indicated above, the positive electrode comprises a positive electrode porous solid-state electrolyte polymer foam, and a positive electrode material, being located in the pores of said positive electrode foam, and the negative electrode comprises a negative electrode porous solid-state electrolyte polymer foam, and a negative electrode material, being located in the pores of said negative electrode foam.

Said foams are therefore porous structures and serve as host structures in which the electrode materials are incorporated.

Said foams are three-dimensional structures.

The design of the foams can be chosen according to the envisaged application or the nature of the electrode active materials.

Thus, a homogeneous pore distribution may be preferred, that is to say a distribution in which the pores all have a similar diameter, it being possible for said pores to be larger or smaller depending on the size of the active material.

For a micrometric material, pores having a diameter of greater than 10 μm may be chosen. For a nanometric material, pores having a smaller diameter (sub-micrometric) may be chosen to ensure a good connection between the various elements.

A distribution of pore size in the electrode may also be envisaged.

A first embodiment may be an embodiment in which pores have a similar diameter throughout the volume of the electrodes, both throughout the volume of the positive electrode and throughout the volume of the negative electrode.

A second embodiment may be an embodiment in which pores located on the separator side have a small diameter and pores located on the current collector side have a larger diameter. In this embodiment, the pores have a diameter increasing from the separator towards the current collector.

A third embodiment may be an embodiment in which pores located on the current collector side have a small diameter and pores located on the separator side have a larger diameter. In this embodiment, the pores have a diameter increasing from the current collector towards the separator.

In the battery cell according to the invention, the pores are interconnected together, thus forming a network making it possible to ensure good ion transport, said network passing through the whole volume of the electrodes.

Preferably, the positive electrode or negative electrode polymer foam has a porosity ranging from 40% to 90%.

The quantification of the porosity can be done by measuring the physical properties of the samples (thickness measurement and weighing) associated with the volume density of the material under consideration, by pycnometry, or by other methods, such as X-ray tomography or focused ion beam-scanning electron microscope tomography.

Advantageously, the positive electrode or negative electrode polymer foam has a thickness ranging from 50 to 1000 micrometers.

According to a particular embodiment, the diameter of the pores of the positive electrode or negative electrode polymer foam ranges from 10 to 100 micrometers.

Preferably, the negative electrode material comprises at least one active material.

According to a particular embodiment, the negative electrode material is chosen from graphites, pure silicons, oxides and composites, and titanates.

Advantageously, said negative electrode material further comprises at least one electron-conducting compound.

According to a particular embodiment, the electron-conducting compound is chosen from carbon black, acetylene black, carbon nanotubes, graphenes, graphite platelets, and mixtures thereof.

Preferably, the positive electrode material comprises at least one active material.

According to a particular embodiment, the positive electrode material is chosen from transition metal oxides and phosphates. Preferentially, the material LiFePO₄ is used.

Advantageously, said positive electrode material further comprises at least one electron-conducting compound.

According to a particular embodiment, the electron-conducting compound is chosen from carbon black, acetylene black, carbon nanotubes, graphenes, graphite platelets, and mixtures thereof.

According to a particular embodiment, the current collector for the positive electrode is composed of aluminum and the current collector for the negative electrode is composed of copper.

A layer for corrosion protection and electrical resistance reduction may be applied to the current collector. This layer consists of at least one polymer binder and at least one electron-conducting compound. The materials of this layer are preferentially identical to those used in the electrodes.

Preferentially, the negative electrode has a thickness ranging from 50 to 1000 micrometers.

Advantageously, the negative electrode has a porosity of less than 20%, preferably of less than 10%.

With preference, the negative electrode comprises from 40% to 75% by volume (or from 50% to 85% by mass) of negative electrode active material, preferably from 50% to 70% by volume (or from 60% to 80% by mass), more preferentially from 55% to 65% by volume (or from 65% to 75% by mass), relative to the total volume (to the total mass) of the electrode.

Advantageously, the negative electrode comprises from 20% to 55% by volume (or from 15% to 40% by mass) of negative electrode polymer foam, preferably from 25% to 45% by volume (or from 15% to 30% by mass), more preferentially from 30% to 40% by volume (or from 20% to 30% by mass), relative to the total volume (to the total mass) of the electrode.

According to a particular embodiment, the negative electrode comprises from 0% to 5% by volume (or from 0% to 5% by mass) of polymer binder, preferably from 1% to 4% by volume (or from 1% to 4% by mass), more preferentially from 2% to 4% by volume (or from 2% to 4% by mass), relative to the total volume (to the total mass) of the electrode.

According to a particular embodiment, the negative electrode comprises from 0% to 5% by volume (or from 0% to 5% by mass) of electron-conducting compound, preferably from 1% to 4% by volume (or from 1% to 4% by mass), more preferentially from 2% to 4% by volume (or from 2% to 4% by mass), relative to the total volume (to the total mass) of the electrode.

The various embodiments for the negative electrode are also valid for the positive electrode, unless indicated otherwise.

The invention further provides a battery comprising at least one cell according to the invention.

The invention also provides a method for manufacturing a battery cell according to the invention, comprising the following steps:

a) manufacturing the separator;

b) producing a first mixture comprising at least one porosity-forming agent, at least one polymer, at least one lithium salt and at least one solvent;

c) coating said first mixture on a first face of said separator, said coating being followed by drying at temperature to obtain a first electrode foam, being the negative electrode foam or positive electrode foam, forming a single structure with the separator;

d) producing a second mixture comprising at least one porosity-forming agent, at least one polymer, at least one lithium salt and at least one solvent;

e) coating said second mixture on a second face of the separator, said coating being followed by drying at temperature to obtain a second electrode foam, being the negative electrode foam if the positive electrode foam was produced in step c) or the positive electrode foam if the negative electrode foam was produced in step c);

steps a) to e) being successive,

f) impregnating the negative electrode foam with a mixture comprising a negative electrode material, said impregnation being followed by drying at temperature;

g) impregnating the positive electrode foam with a mixture comprising a positive electrode material, said impregnation being followed by drying at temperature;

it being understood that step f) may take place before step g), or after step g), or even at the same time as step g); then

h) drying the assembly at temperature.

Preferably, the first mixture and the second mixture are identical.

Advantageously, the porosity-forming agent is chosen from glycerol, isopropanol, dibutyl phthalate, and mixtures thereof.

The polymer of said first mixture and/or of said second mixture may comprise poly(ethylene oxide).

The first mixture and/or the second mixture may further comprise poly(vinylidene fluoride-co-hexafluoropropylene).

Particularly preferably, the same polymer(s) and the same lithium salt(s) are used in the separator, the first mixture and the second mixture.

Preferentially, during step c) and/or e), the drying at temperature is carried out at a temperature ranging from 105 to 135° C., preferably ranging from 110 to 130° C., optionally under vacuum.

According to a particular embodiment, during steps f), g) and h), the drying at temperature is carried out at a temperature ranging from 90 to 110° C.

According to a particular embodiment, after step h), the current collector for the negative electrode and the current collector for the positive electrode are installed.

Other advantages and features of the invention will become more clearly apparent on examination of the detailed description, given solely by way of non-limiting examples, and with reference to the appended drawings in which:

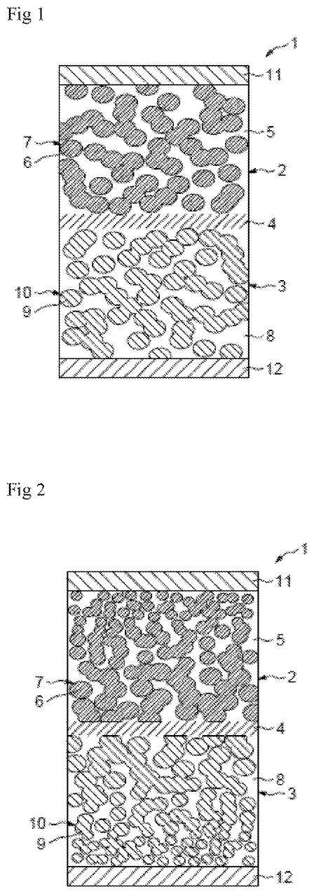

FIG. 1 is a schematic view of an embodiment of a battery cell according to the invention;

FIG. 2 is a schematic view of another embodiment of a battery cell according to the invention;

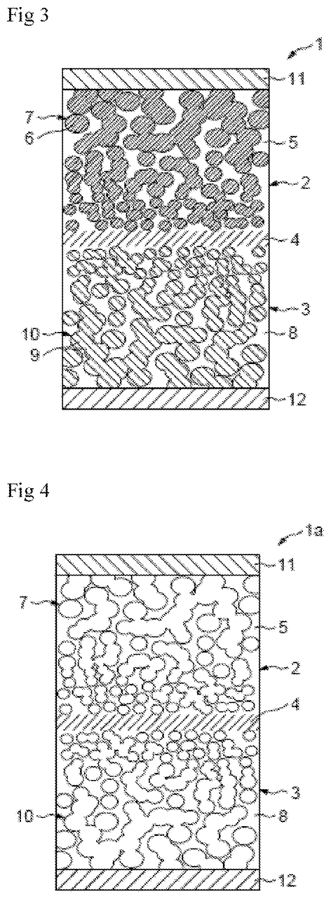

FIG. 3 is a schematic view of another embodiment of a battery cell according to the invention;

FIG. 4 is a schematic view of a structure comprising in particular porous polymer foams.

### EXAMPLES

Hereinbelow, reference will be made to FIGS. 1 to 3 which illustrate several embodiments of a battery cell according to the invention. Reference will also be made to FIG. 4 which shows a structure comprising in particular a positive electrode polymer foam and a negative electrode polymer foam.

As can be seen in FIG. 1, the battery cell according to the invention 1 comprises a positive electrode 2, a negative electrode 3 and a separator 4.

The positive electrode 2 comprises a positive electrode porous solid-state electrolyte polymer foam 5, and a positive electrode material 6, said material 6 being located in the pores 7 of said positive electrode foam.

The negative electrode 3 comprises a negative electrode porous solid-state electrolyte polymer foam 8, and a negative electrode material 9, being located in the pores 10 of said negative electrode foam.

The foam 5 is connected to the current collector 11, which is a current collector made of aluminum. The foam 8 is connected to the current collector 12, which is a current collector made of copper.

In this FIG. 1, the pores 7 and 10 have a similar diameter throughout the volume of the positive electrode and throughout the volume of the negative electrode, respectively.

However, as stated above, a different pore distribution is possible.

According to another embodiment, as illustrated in FIG. 2, the distribution of the pores is such that the pores 7 and 10 located on the current collector side have a small diameter and the pores 7 and 10 located on the separator side have a larger diameter. In this FIG. 2, the pores 7 and 10 have a diameter increasing from the current collector towards the separator.

According to yet another embodiment, as illustrated in FIG. 3, the distribution of the pores is such that the pores 7 and 10 located on the separator side have a small diameter and the pores 7 and 10 located on the current collector side have a larger diameter. In this FIG. 3, the pores 7 and 10 have a diameter increasing from the separator towards the current collector.

The battery cell according to the invention 1 can be prepared according to an example of a manufacturing method as described hereinbelow.

Separator

The separator 4 is manufactured first of all. It is preferentially a nonporous polymer film 4.

Poly(ethylene oxide) (PEO), a polymer binder, poly(vinylidene fluoride-co-hexafluoropropylene) (PVdF-HFP), and at least one lithium salt (chosen from LiTFSI, LiFSI, LiPF₆ and mixtures thereof) are dissolved in a solvent chosen from dimethylformamide (DMF), acetonitrile, and a mixture thereof.

The content of PVdF-HFP can range from 5% to 50% by mass, relative to the mass of the PEO.

The content of lithium salt can range from 5% to 20% by mass, relative to the PEO.

The polymer (PEO+PVdF-HFP)/solvent mass ratio is preferably set at 1:4.

Degassing of the solution is then carried out by magnetic stirring under vacuum.

The coating of the film is then carried out with a doctor blade or nozzle system. Next, drying at temperature is carried out at a temperature that can range from 60 to 130° C., optionally under vacuum, to evaporate the solvent.

The thickness of the film is then reduced by calendering.

Thus, a preferentially nonporous film 4 is obtained. It is used as separator between the two electrodes 2 and 3, with its role of insulating electrically and conducting ions.

Negative Electrode or Positive Electrode Foam

A foam 5 or a foam 8 is then produced on the separator 4 manufactured in the previous step.

A porosity-forming agent, as indicated above, may be used. This is a liquid referred to as non-solvent which, once removed, leaves a network of porosity in the sample. A “star polymer” PEO is used. This polymer is from the same family of materials as the PEO of the separator film 4.

Thus, compatibility between the layers is promoted and hence ion transport is promoted.

A mass content of 40% by mass of PEO “star polymer” may be used. This content can make it possible to achieve a porosity of close to 80%. Then, PVdF-HFP is used. Its use promotes mechanical strength.

The PVdF-HFP powder, the PEO and at least one lithium salt (chosen from LiTFSI, LiFSI, LiPF₆, and mixtures thereof) are dissolved in a mixture of DMF (solvent) and glycerol (non-solvent). Mixing is effected by magnetic stirring at 80° C. for 10 hours. A step of degassing by magnetic stirring under vacuum is then carried out.

Then, a conventional coating step carried out with a doctor blade or nozzle system is carried out on a first surface of the separator 4 obtained in the previous step.

The presence of DMF at the interface between the film and the solution makes it possible to redissolve the PVdF-HFP at the surface of the film 4.

Drying at temperature at 120° C. for 12 hours is then carried out, allowing the evaporation of the solvent and the non-solvent.

The structure is then fixed, and the first negative electrode or positive electrode electrolyte foam is formed. It may therefore be foam 5 or foam 8.

In addition, the interface between the foam 5 (or 8) and the separator 4 is merged, and there is then no longer any physical interface between the foam 5 (or 8) and the separator 4. The observation can be carried out by scanning electron microscopy on a section of the sample, by measuring conductivity/resistivity. In the present case, an absence of demarcation between the two layers is observed.

At this stage, a single structure formed by the separator and a first negative electrode or positive electrode foam (foam 5 or foam 8) is obtained.

Negative Electrode or Positive Electrode Foam

A negative electrode or positive electrode polymer foam is then produced (foam 5 or foam 8) on the single structure obtained on conclusion of the previous step.

Thus, if foam 5 was produced in the previous step, then foam 8 is produced. If foam 8 was produced in the previous step, then foam 5 is produced.

In this step, the entire procedure used in the previous step is repeated, but the step of coating the second mixture comprising at least one porosity-forming agent, at least one polymer, at least one lithium salt and at least one solvent, is carried out on the second face of the separator 4.

Thus, the assembly formed by the foam 5, the foam 8 and the separator 4 forms a one-piece structure.

At this stage, the pores 7 and 10 of the foams 5 and 8 are empty, as illustrated in FIG. 4 which then represents a structure 1a.

The filling of the pores 7 and 10 is carried out by impregnating a mixture comprising a positive electrode material, material 6, with regard to foam 5, and by impregnating a mixture comprising a negative electrode material, material 9, with regard to foam 8.

Said mixtures comprising materials 6 and 9 can be in the form of an ink.

For example, foams 5 and 8 can be immersed in a bath of said inks. The ink infiltrates the pores 7 and 10 of foams 5 and 8.

Impregnation may also be carried out by coating with a doctor blade or nozzle system.

This impregnation is followed by drying at temperature, at a temperature ranging from 90 to 110° C., optionally under vacuum, which makes it possible to dry the mixture and fix it within the foam.

Then, in a conventional manner, the current collector for the negative electrode and the current collector for the positive electrode are installed. Thus, in the present embodiment, the aluminum current collector 11 is connected to the foam 5. The copper current collector 12 is connected to the foam 8.

The anode and cathode current collectors may have a coating of carbon or of carbon mixed with PEO/poly(vinylidene fluoride-co-hexafluoropropylene) to improve the interface with the active material and the polymer foam.

Thus, a battery cell according to the invention is obtained.

1-13. (canceled)

14. A battery cell comprising:
at least one positive electrode, at least one negative electrode, and at least one separator,
said positive electrode comprising:
a positive electrode porous solid-state electrolyte polymer foam, said positive electrode foam comprising at least one lithium salt, and
a positive electrode material located in pores of said positive electrode foam, said negative electrode comprising:
a negative electrode porous solid-state electrolyte polymer foam, said negative electrode foam comprising at least one lithium salt, and
a negative electrode material located in pores of said negative electrode foam.

15. The cell as claimed in claim 14, wherein said positive electrode foam and said negative electrode foam are of a same chemical nature.

16. The cell as claimed in claim 14, wherein said positive electrode foam comprises poly(ethylene oxide).

17. The cell as claimed in claim 14, wherein the negative electrode foam comprises poly(ethylene oxide).

18. The cell as claimed in claim 14, wherein said lithium salt is chosen from lithium bis(trifluoromethanesulfonyl)imide, lithium bis(fluorosulfonyl)imide, lithium hexafluorophosphate (LiPF₆), and mixtures thereof.

19. The cell as claimed in claim 14, wherein the separator is a polymer film comprising poly(ethylene oxide).

20. A battery comprising:
at least one of the cell claimed in claim 14.

21. A method for manufacturing the cell as claimed in claim 14, the method comprising:
a) manufacturing the separator;
b) producing a first mixture comprising at least one porosity-forming agent, at least one polymer, at least one lithium salt and at least one solvent;
c) coating said first mixture on a first face of said separator, said coating being followed by drying at temperature to obtain a first electrode foam, the first electrode foam being the negative electrode foam or positive electrode foam, forming a single structure with the separator;
d) producing a second mixture comprising at least one porosity-forming agent, at least one polymer, at least one lithium salt and at least one solvent;
e) coating said second mixture on a second face of the separator, said coating being followed by drying at temperature to obtain a second electrode foam, the second electrode foam being the negative electrode foam when the positive electrode foam was produced in step c) or the positive electrode foam when the negative electrode foam was produced in step c);
steps a) to e) being successive,
f) impregnating the negative electrode foam with a mixture comprising the negative electrode material, said impregnation being followed by drying at temperature;
g) impregnating the positive electrode foam with a mixture comprising the positive electrode material, said impregnation being followed by drying at temperature;
wherein step f) takes place before step g), or after step g), or at a same time as step g); then
h) drying the assembly at temperature.

22. The method as claimed in claim 21, wherein the first mixture and the second mixture are identical.

23. The method as claimed in claim 22, wherein the porosity-forming agent is chosen from glycerol, isopropanol, dibutyl phthalate, and mixtures thereof.

24. The method as claimed in claim 22, wherein the polymer of said first mixture and/or of said second mixture comprises poly(ethylene oxide).

25. The method as claimed in claim 22, wherein, during step c) and/or e), the drying at temperature is carried out at a temperature ranging from 105 to 135° C.

26. The method as claimed in claim 22, wherein, during step c) and/or e), the drying at temperature is carried out at a temperature ranging from 110 to 130° C.

27. The method as claimed in claim 22, wherein, during step c) and/or e), the drying at temperature is carried out under vacuum.

28. The method as claimed in claim 22, wherein, during steps f), g) and h), the drying at temperature is carried out at a temperature ranging from 90 to 110° C.
